(19) United States
(12) Patent Application Publication
(10) Pub. No.: US 2017/0023368 A1
(43) Pub. Date: Jan. 26, 2017

(54) MULTI-WAYPOINT SEMANTIC-DRIVEN ITINERARY GUIDANCE TO SITUSES WITHIN BUILDINGS

(71) Applicant: Compass Technologies, LLC, Blaine, MN (US)

(72) Inventor: Nick Guse, Blaine, MN (US)

(21) Appl. No.: 14/805,264

(22) Filed: Jul. 21, 2015

(51) Int. Cl. G01C 21/20

(52) U.S. Cl. CPC G01C 21/206

(57) ABSTRACT

Apparatus and associated methods relate to delivering real time navigation and itinerary guidance in response to semantic information associated with at least one target situs located within a building. In an illustrative example, a handheld device operator may input the semantic information about at least one desired situs destination. In some embodiments, the operator may input semantic information for each of two desired situs locations, respectively, in two situs buildings. Time-dependent itinerary information displayed to the operator on the handheld device may include, for example, estimated arrival time, dwell time, and/or departure time in order to maintain a user-defined itinerary schedule. For example, a server may deliver time dependent situs semantic and mapping information to a mobile device in response to a user request containing semantic information associated with the situs. The mapping information may guide the operator through the building to the situs.

### TECHNICAL FIELD

Various embodiments relate generally to real-time navigation intelligence based on semantic information about at least one situs within a building.

### BACKGROUND

Commercial facilities, and buildings in particular, vary widely in design and architecture. The era in which the building was designed, and the type of architectural design employed in its construction, may impact its physical layout. Many large buildings are unique.

For example, some complexes have been constructed over years or decades. The design and architecture employed to erect each building in the complex may evolve over time. Consequently, in some complexes, such as universities, airports, casinos, hotels, conference centers, malls, or hospitals, for example, the layout and design of the space within different buildings or areas of the complex may be very different.

In addition to possible unique differentiators between various buildings, the use of the space within the building may vary over time. In a shopping center with many vendors, for example, the use of particular storefronts in the shopping center may vary over time as the businesses that lease the space change, or move in or out. In another example, the purpose of any particular classroom in a university building may change multiple times per day according to the various courses scheduled to be taught in that room.

### SUMMARY

Apparatus and associated methods relate to delivering real time navigation and itinerary guidance in response to semantic information associated with at least one target situs located within a building. In an illustrative example, a handheld device operator may input the semantic information about at least one desired situs destination. In some embodiments, the operator may input semantic information for each of two desired situs locations, respectively, in two situs buildings. Time-dependent itinerary information displayed to the operator on the handheld device may include, for example, estimated arrival time, dwell time, and/or departure time in order to maintain a user-defined itinerary schedule. For example, a server may deliver time dependent situs semantic and mapping information to a mobile device in response to a user request containing semantic information associated with the situs. The mapping information may guide the operator through the building to the situs.

Various embodiments may achieve one or more advantages. For example, some embodiments may promote productive planning of a multi-waypoint itinerary. Exemplary applications that may advantageously save time and enable the operator to accomplish more tasks may, by way of example and not limitation, include at least indoor shopping (e.g., at a mall, a grocery store, book store, department store), or otherwise navigating in complex buildings (e.g., at airports, hospitals, educational campuses, malls, cruise ships, amusement parks, recreational facilities, community centers, or the like). Various examples may optimize efficient and productive navigation through one or more waypoints located in one or more buildings by notifying the operator, for example, when to depart in order to maintain the itinerary schedule. In various embodiments, a system may advantageously supersede the functionality of a conventional static kiosk, such as may be erected in a mall, by providing real-time navigation and itinerary information with respect to transit from the user's current location, through an itinerary of one or more waypoints, and ending at a suitable desired end location.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an illustration of an exemplary multi-waypoint semantic-driven itinerary guidance system (MWSDIGS) for intra-building navigation to situses in a retail center within a single situs building.

FIG. 2 depicts an illustration of an exemplary MWSDIGS for intra-building navigation to situses in multiple situs buildings in an educational campus.

FIG. 3 depicts a schematic view of an exemplary MWSDIGS implemented on a mobile client and a remote server.

FIG. 4 depicts a flowchart of exemplary MWSDIGS operations executed on a mobile client.

FIG. 5 depicts a flowchart of an exemplary MWSDIGS operations executed on a remote server.

FIG. 6 depicts an exemplary user interface for a MWSDIGS application on a mobile client.

Like reference symbols in the various drawings indicate like elements.

### DETAILED DESCRIPTION OF ILLUSTRATIVE EMBODIMENTS

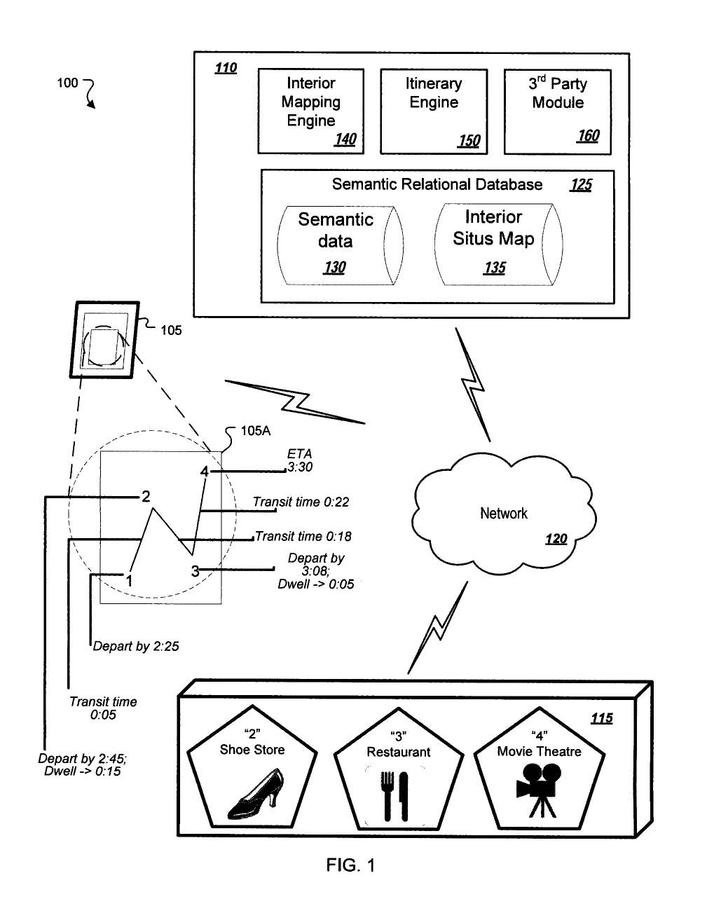

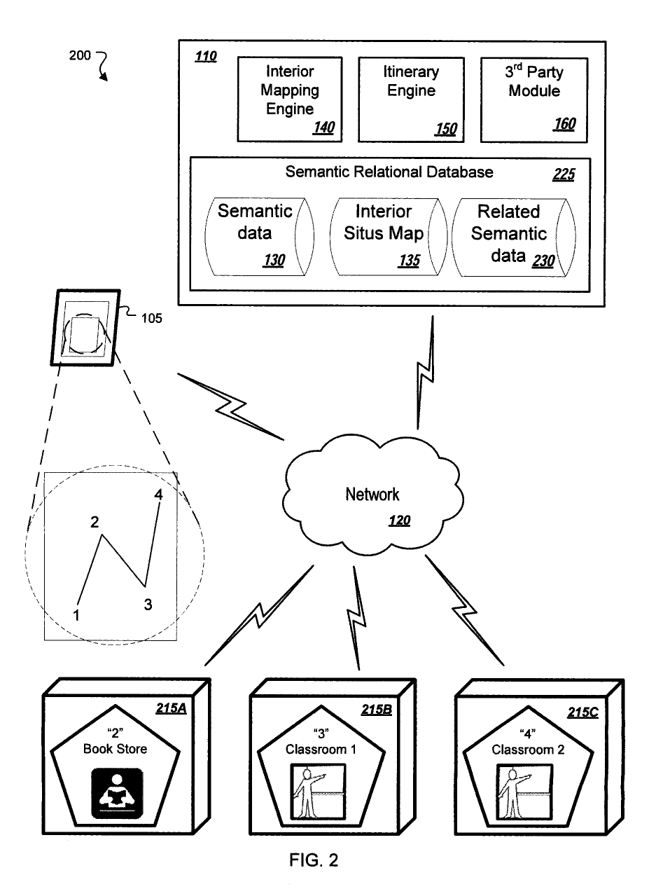

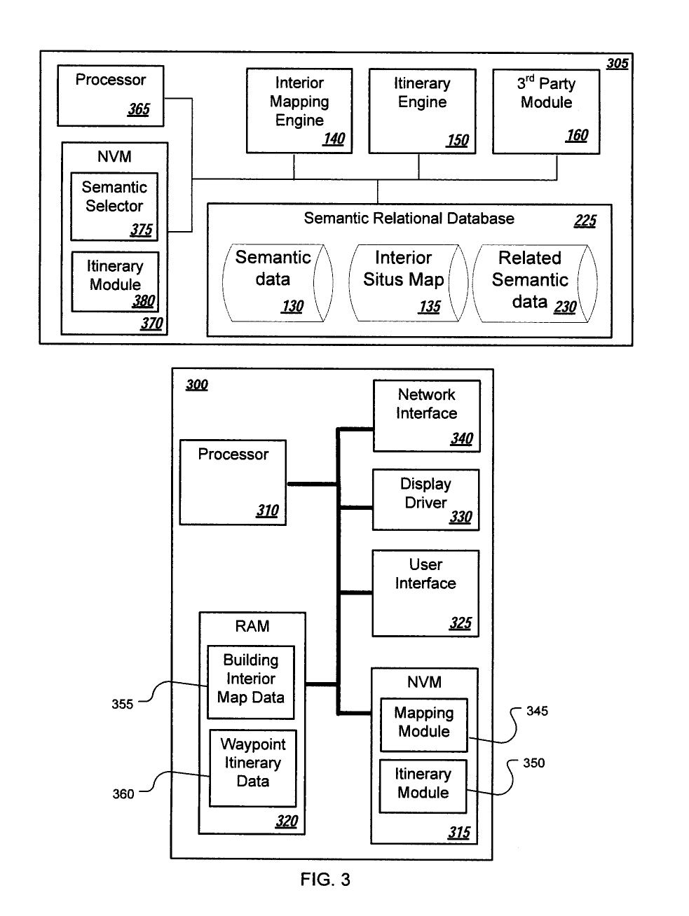

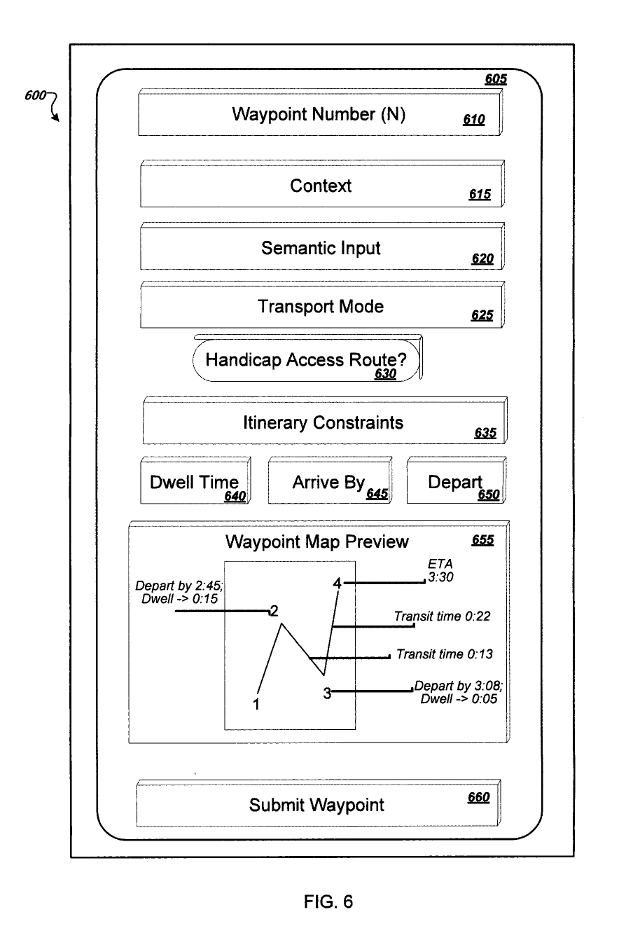

To aid understanding, this document is organized as follows. First, two exemplary applications of a MWSDIGS, namely a shopping mall and an educational campus, are briefly introduced with reference to FIGS. 1-2. Second, with reference to FIGS. 3-5, the discussion turns to exemplary embodiments that illustrate hardware architecture and software flowcharts for operation on a mobile client device and a remote server. Finally, with reference to FIG. 6, further explanatory discussion is presented for an exemplary user interface by which a user may define a multi-waypoint itinerary request using the MWSDIGS client device.

FIG. 1 depicts an illustration of an exemplary multi-waypoint semantic-driven itinerary guidance system (MWSDIGS) for intra-building navigation to situses in a retail center within a single situs building. In the depicted figure, a MWSDIGS 100 includes a mobile (e.g., handheld, portable) device 105 in operative communication with a MWSDIGS server 110. The server 110 receives and stores mapping and semantic information supplied from third parties, in this example, located at multiple stores in a retail shopping center 115. In this example, all of the stores in the shopping center 115 are located within a single building. In some examples, the server communicates with the shopping center 115 and the mobile device 105 via a network 120. In operation, a user may input semantic information to the device 105 using an application program (e.g., app). The device 105 may request from the server 110 mapping information to a situs that matches the user input semantic information. Upon receipt of the response from the server 110, the device 105 may present for display to a user real time, time dependent itinerary information to the user via a display device 105A. In the depicted example, the device display 105A may present itinerary information including, but not limited to, estimated time of arrival (ETA), depart by, and dwell times at one or more waypoints. The device display 105A may further include transit and graphical navigational directions between user selected waypoints.

The device display 105A, in the depicted example, indicates an ETA of 3:30. This may be calculated by the device 105 based on user-input semantic information and constraints. The user input semantic information may be sent to the server 110, which may respond with waypoint, or situs, information associated in the server 110 with semantic information matching the user request. The device 105 may further receive mapping information from the server 110. The device 105 may determine, either internally or from the server 110, transit times and constraints supplied by the user and/or third party operators of the situses. With this information, the device 105 may compute a depart by time for the user's current location in order to satisfy all the temporal constraints. The device 105 may further compute an ETA at one or more waypoints. The user may display desired itinerary information, which the user may control by appropriate selection of display filter options. In some embodiments, the critical path constraints may be turned on or emphasized (e.g., colorized, highlighted).

The server 110 includes a semantic relational database 125 for storing semantic data 130 and interior situs maps 135, and links that associate such data records. The server 110 also includes an interior mapping engine that accesses selected ones of the interior situs maps 135 to supply them to the device 105 upon request. The server 110 includes an itinerary engine 150 operative to process semantic information received in a request, match that to semantic records in the semantic data 130, call on the interior mapping engine 140 to retrieve the appropriate interior situs map records 135, and generate an itinerary package to send to the device 105. The itinerary package may include, for example, locations of each selected situs within the situs building, and situs building mapping information for each selected situs. As will be described in further detail with reference to FIG. 2, the itinerary engine 150 may further include in the itinerary package additional situs operator-supplied semantic information associated with the situs that was not included in the received request from the user. The server 110 also includes a third party module 160 to receive and store records of situs location, mapping and semantic information supplied by third parties. In some examples, the third party module 160 receives information from operators of a situs or the building that contains the situs. In some cases, third party information may be supplied to the third party engine 160 from independent parties unrelated to the situs operation, such as, for example, private or publicly available databases, government information sources, and/or private information vendors. The third party module 160 may process, approve, and store information about interior navigational pathways and/or semantic information about one or more situses in the database 125.

In an illustrative example, the user may make inputs via a user interface to define 3 waypoints to visit in sequence for an itinerary. The MWSDIGS system 100 may operate to display to the user navigational information from a current location of the user (“1” on the figure) to, in sequence, a shoe store (“2” in the figure), a certain type of restaurant (“3” in the figure) and a movie theatre (“4” in the figure). Each of the shoe store, restaurant, and movie theatre can be entered by navigation to a corresponding situs within the situs building, retail center 115. In order to make navigation possible within the situs building of retail center 115, the three vendors and retail center 115 each contribute mapping and/or semantic information that defines the physical location and access points (e.g., entrances) within the situs building. For example, the retail center 115 operators may provide mapping information for all available access ways, passages, corridors, conveyances (e.g., rail, bus, stairs, elevators, escalators, and exits into the building, and into each participating retailer. Using this information should be sufficient for a mapping program module to generate a navigational path from a user location (while holding the handheld device 105) within the situs building to at least one entrance of any of the participating retailers' situses.

In order to make rich content available to the user of the device 105, the retailers may supply semantic information to indicate certain functional information about the operations at the situs of each participating retailer. For example, a shoe store catering primarily to women's and children's specialty shoes may include semantic information such as, “shoes” and more specific semantic information, such as “sneakers, women's golf shoes, children's pool shoes, women's running shoes, pumps.” The restaurant may, for example, specify semantic information about its specialty in Western European food items, in addition to its general category of “restaurant, food.” The restaurant may further indicate semantic information about its prices, atmosphere, star rating, speed, operating hours, and specific menu items (e.g., schnitzel, pesto, croissants). The movie theatre may regularly supply updates to the server 110 of its semantic information to include movie genres, start times, titles, ratings, and links to trailers, for example.

With this sort of semantic information stored and associated with the location information of the situs, the server 110 can respond to requests from the device 105. The requests may represent one or more waypoints of an itinerary. The itinerary may include temporal constraints, such as dwell time at a waypoint, transit time between waypoints, depart by time (in order to maintain schedule without violating any constraints in the itinerary), and arrive by time.

In operation the device 105 may display or otherwise indicate (e.g., by audible voice or tones, vibration, electronic messages, or the like) temporal constraints and/or status information. For example, the device 105 may be programmed with a computer program product containing instructions that, when executed, cause the device to indicate an estimated time of arrival (ETA), or a variance in the itinerary. Itinerary variances may be displayed on a display 105A as either positive or negative. In some example, a negative variance in the itinerary may relate to a waypoint at which an ETA is later than an “arrive by” constraint. Various alarms or audible, kinetic, or visible indicia may indicate the potential or actual occurrence of a negative itinerary variance. A positive variance may represent additional slack time available to meet all the constraints on the itinerary. The variance may be computed in response to user request, at the occurrence of certain predetermined events (e.g., arrival at a waypoint), and/or at periodic intervals (e.g., once per 10 seconds, once per minute, once per 5 minutes, for example.

In various examples, the network 120 may include one or more wide area and/or telecommunication networks, for example, such as the Internet. By way of example and not limitation, the communications via the network 120 among the device 105, server 110, and center 115 may include transport of electronic packetized messages via links that may be wired, wireless, optical, or a combination of such communication links.

Although not shown, some embodiments may include systems for determining the current location of the mobile device 105 within the situs building 115. By way of example and not limitation, the user location may be determined, either alone or in combination, by GPS (global positioning systems), local RFID sensor tracking, triangulation (e.g., using Wi-Fi), bar code scanning stations, or inertial sensors (e.g., accelerometers) in the device 105. Some systems may also provide for manual updates of user location, either by typing, or by optical pattern recognition of landmarks using a camera available on the device 105.

Continuing with the illustrative example, a user may access the MWSDIGS app on the device 105 while in a parking garage attached to a mall, such as the retail center 115. While in the car, the operator may load or enter a set of waypoint criteria using a user interface, an example of which is described in further detail with reference to FIG. 6. The current user location is identified as “1” with the subsequent waypoints identified as “2-4.” As shown in the detail of the display 105A, the device generates a 4 waypoint navigational path represented in the form of a map. In some embodiments, the displayed navigational path may be overlaid (not depicted) with details of the internal building access corridors and available pathways. In some embodiments, the navigational path may be represented by directions in textual or audible format. For example, a part of navigational path from the situs of a shoe store to the situs of the restaurant may include “walk straight for 20 feet. Turn to the left and go up two flights of escalators to the 4^{th} floor. At the top of the escalator, go straight to end of the hall, then turn left. Your “restaurant” is the second store on the right.”

Associated with each waypoint and path between waypoints are indicated on the display 105A itinerary information. In some embodiments, some itinerary information may be supplied by the third party (e.g., retailer) for that situs. For example, the situs building operator may provide semantic information about modes of transit available between situses. In an airport, for example, the airport operator may provide tram, moving walkways, elevators, escalators, electric carts, busses, trains, and/or walking paths. The airport operator may provide additional semantic information about transit times, such as the transit schedule for the tram, and estimated times of transit using each form of transit. Using this information, the device 105 may generate estimate transit times between waypoints. In some embodiments, the server 110 may generate navigational paths and/or generate transit time estimates in response to navigational path information supplied by the device 105.

Constraints at a waypoint may be defined, for example, as desired dwell time at a waypoint, arrive by times, and depart by times. Some constraints may be supplied by the third party operator of the situs. The user may input constraints to build an itinerary, as will be described in further detail with reference to FIG. 6. The device 105 may be programmed to suggest default constraints. Some third parties may suggest semantic information that includes default constraints (e.g., restaurants may suggest a dwell time required to complete a typical meal) that may be optionally overridden by the user. For example, a movie theatre situs may be associated with suggested default “arrive by” time constraints corresponding to semantic information (e.g., a movie title and a start time) selected by the user for that situs.

FIG. 2 depicts an illustration of an exemplary MWSDIGS for intra-building navigation to situses in multiple situs buildings in an educational campus. In the depicted figure, a MWSDIGS 200 includes a mobile (e.g., handheld, portable) device 105 in operative communication with a MWSDIGS server 110 to generate a 3 situs itinerary, where the three situses, a book store, a classroom 1, and a classroom 2, are located in three separate buildings, 215A, 215B, and 215C, respectively. In this example, the server 110 includes a semantic relational database 225 that includes related semantic data 230 that contains additional third party supplied semantic information useful to generate the itinerary.

In an illustrative example, a university third party educational provider, may operate situs buildings 215A-215C, the bookstore, and their classrooms 1, 2. The university may supply to the third party module 160 semantic information that may apply constraints on the itinerary generated by the itinerary engine 150. For example, the book store, depicted as waypoint “2,” may be associated with operating hours (e.g., open and close times). The device 105 may access time and date information pertaining to the itinerary of a student using the MWSDIGS app. When the student defines an itinerary waypoint for the situs of the bookstore “2,” the additional semantic information may prevent the student from entering an arrive by time or dwell time that falls outside of the hours of operation information associated with that situs.

As another example, the student may enter semantic information as a course identifier (e.g., SCI 227) representing a course name in the science department and course number. The university may supply course schedule and other semantic information relevant to that course, and the third party module 160 may store that supplied information into the appropriate semantic data 160, interior situs map 135, and related semantic data 230 repositories, along with the proper associative links to the situs of the classroom where that course will meet for lectures, labs. If, for example, the course location or schedule varies from time to time, current schedule and situs information may be disseminated to the faculty and students via an update to the appropriate record in the related semantic data 230. When the student enters the SCI 227 course into the app, the app uses the related semantic schedule data to establish arrive by and dwell times that will automatically appear as an overridable suggestion in any itinerary the student creates that overlaps the meeting times for that course.

In some implementations, the related semantic data associated with the course may further include the office hours of the instructor, and may include arrive by and depart time restrictions associated with the situs for the office hours. In some implementations, the related semantic data associated with the course may further include situs information associated with arrive by and depart time restrictions for course examinations, review classes, field trips, or the like.

In the depicted example, portions of the itinerary involve navigation between exterior buildings. In some implementations, mapping information to navigate from an exit of one situs building (e.g., 215A) to an entrance of a subsequent situs building (e.g., 215B) may be received by the interior mapping engine 140. Segments of door-to-door travel may be prepared using commercially available conventional mapping techniques (e.g., GPS). In some cases, the exterior mapping information for navigating between situs buildings may be provided by the third party, such as an educational campus operator, for example.

FIG. 3 depicts a schematic view of an exemplary MWSDIGS implemented on a mobile client and a remote server. The MWSDIGS includes a mobile client 300 and a remote MWSDIGS server 305 that cooperate to generate multi-waypoint itinerary guidance information for intra-building navigation to situses based on user input semantic information. The client device 300 includes a processor 310 coupled by bus, data, and control lines to a non-volatile memory (NVM) 315 for storing program instructions, a random access memory (RAM) 320 for temporary storage of data, a user interface 325 for receiving user input, a display driver 330 for sending information for display on a display device (e.g., screen), and a network interface 340 for communicating via a communication link to the remote server 305.

Exemplary program instructions for execution on the processor 310 may be stored in the NVM 315. The MWSDIGS app may be performed by executing a mapping module 345 or an itinerary module 350 on the processor 310, for example. In some embodiments, the mapping module may receive mapping information, situs location information, and itinerary information from the itinerary module 350, and generate a navigational path representation, which may be in graphical or textual form, for example, for presentation to the user. The mapping module 345 may cause the processor to send graphical representation information about the navigational path and associated itinerary information for display via the display driver 330.

The itinerary module 350 may, for example, receive user input semantic information from the user interface 325, generate a request message for transmission to the server 305 via the network interface 340, and calculate itinerary information for display. The itinerary module may receive constraint information associated with each situs from the user interface 325, or from the server 305 via the network interface 340.

The programs in NVM 315 may access the RAM 320 to manage building interior map data 355, and waypoint itinerary data 360. As new information is updated or processed by the program instructions 345, 350, the corresponding mapping and semantic data may be updated by accessing the assigned data stores in the RAM 320, including the data stores 355, 360.

The server 305 further includes a processor 365 connected by a bus, data, and control lines to the interior mapping engine 140, itinerary engine 150, the third party module 160, and the semantic relational database 225. In the depicted embodiment, the processor 365 is further operatively connected to a non-volatile memory (NVM) 370. The NVM 370 stores a semantic selector module 375, and an itinerary module 380. When executed by the processor 365, the semantic selector module may access the semantic data 130 to find one or more matching situses associated with semantic information that matches the semantic information requested by the user. In some embodiments, the semantic selector 375 may further base its selection or direct its search using context information supplied by the user.

In some examples, context information may include the context in which meaning may be ascribed to the semantic information. By way of example and not limitation, some exemplary contexts that may be used to categorize or select situses may include: shopping, working, educational campus, sporting event, conference event, casino, cruise ship, hotel complex, shopping mall, hospital complex, airport, museum, and travel. The semantic selector module 375 may, in some embodiments, use context to filter out situses that match the semantic value but are out of context.

The itinerary module 380 may, when executed by the processor 365, cause the processor to perform operations to retrieve and assemble situs location, mapping, and related semantic information associated with the situses selected by the semantic selector 375. The itinerary module 380 may cooperate with the itinerary engine 150 to prepare the itinerary packages for transmission to the client device 300.

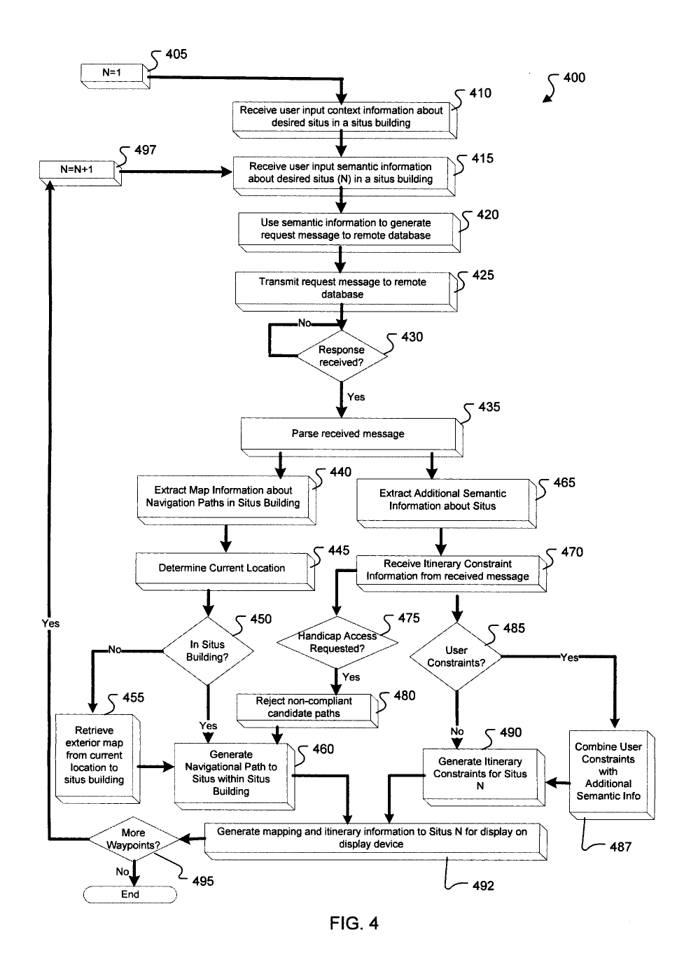

FIG. 4 depicts a flowchart of exemplary MWSDIGS operations executed on a mobile client. In some examples, some of the steps in a method 400 may be included in the program instructions of the mapping module 345 and the itinerary module 350, for example. At step 405, the processor (e.g., processor 310) initializes a waypoint variable count, N=1. Then, at 410, the device 300 receives user input context information about desired situs in a situs building for the Waypoint N. Then, at 415, the device 300 receives user input semantic information about desired situs in a situs building for the Waypoint N. At 420, the processor uses semantic information to generate a request message to a remote database. The client transmits the request message to the remote database at 425. If, at 430, the client device has received no response to this request, it continually repeats checking at 430.

If, at 430, the client device has received a response to this request, it causes the client to extract map information about navigation paths in the situs building at 440. In this example, the client determines current location at 445. If, at 450, the determined current location is not in a situs building stored in the server database, then, at 455, the client retrieves exterior map information from the user's determined location to the situs building. Then, at step 460, or if at 450, the determined current location is in a situs building stored in the server database, the client generates a navigational path to the situs within the situs building.

If, at 430 again, the client device has received a response to this request, the processor operates at 465 to extract additional semantic information about situs. The client receives itinerary constraint information from the received message at 470. If at 475, the user has requested handicap accessible routes, then, at 480, the client rejects non-compliant candidate paths from those generated at 460.

Based on the constraints received in step 470, if any, the client determines whether the user has input any constraints on the itinerary at 485. If the user has input constraints, then at 487 the client combines the user constraints with the received constraints and any additional pertinent semantic information. Then, or if the user has not input constraints at 485, then the client generates itinerary constraints for Situs N at 490.

At 492, the client applies the navigational paths generated at 460 and the itinerary constraints generated at 490 to generate mapping and itinerary information to Situs N for display on a display device.

Then, the client checks whether there are more waypoints to process at 495. If there are more waypoints to process, then the client increments N=N+1 at 497 and returns to 415. Otherwise, the process ends.

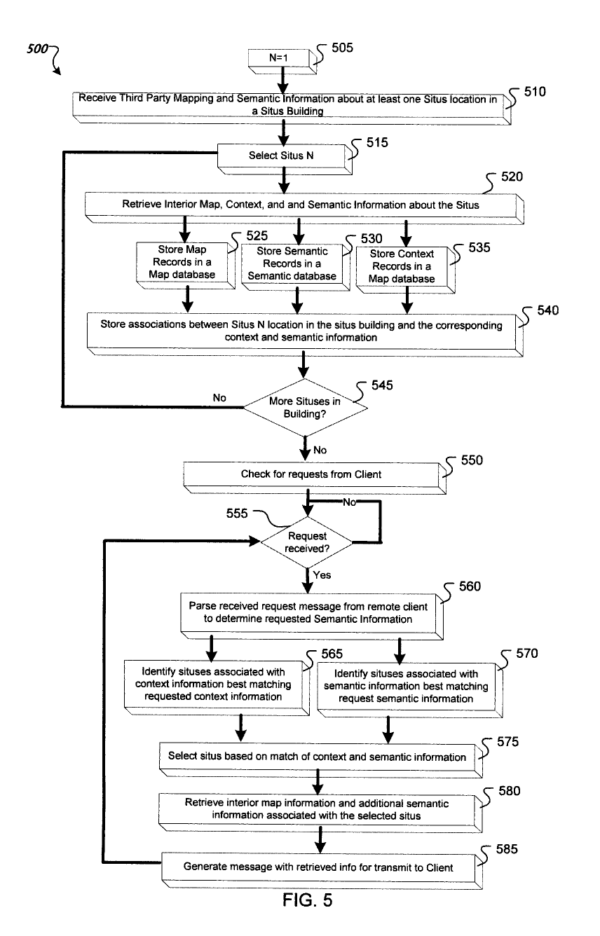

FIG. 5 depicts a flowchart of an exemplary MWSDIGS operations executed on a remote server. In some examples, some of the steps in a method 500 may be included in the program instructions of the semantic selector module 375 and the itinerary module 380, for example. Some operations may be included, in some embodiments, in the interior mapping engine 140, the itinerary engine 150, and/or the third party module 160.

At step 505, the processor (e.g., processor 365) initializes a waypoint variable count, N=1. Then, at 510, the server 305 receives third party mapping and semantic information about at least one situs in a situs building. At 515, the server selects a Situs N. Next, the server retrieves interior map, context and semantic information about the selected Situs N.

Next the server stores the retrieved map records in a map database at 525, stores the retrieved semantic records in a semantic database at step 530, and stores the retrieved context records in a context database at step 535. Then, the server stores associative links between the Situs N location in the situs building and the corresponding context and semantic information at 540. At 545, if there are more situses in the situs building to process, then the server increments N and loops back to step 515.

If, at 545, there are no more situses in the situs building to process, then the server repeatedly checks, at 555, for request messages from the Client 300. When a request message is received, then the server parses the received request message from the remote client to determine requested semantic information at 560. Then, the server identifies situses associated with context information best matching requested context information at 565. The server also identifies situses associated with semantic information best matching requested semantic information at 570. Then, at 575, the server selects a situs based on match of context and semantic information. The server retrieves, at 580, interior map information and additional semantic information associated with the selected situs. Finally, the server generates a message with the retrieved information for transmission as an itinerary package to the client. Then, the server loops back to repeat step 555.

FIG. 6 depicts an exemplary user interface for a MWSDIGS application on a mobile client. A client device displays a user interface 600 within a display region 605. The user selects (e.g., by drop down list box, on screen keyboard, or the like) a waypoint number in user input control (UIC) 610, which number may indicate a sequence of waypoints. Exemplary sequences of multiple waypoints were described with reference to FIGS. 1-2.

For the selected waypoint number, the user may optionally select a context in a UIC 615. When selected, UIC 615 may display a predetermined list of available contexts. The number of available contexts may be controlled by the server operator based on a subscription level the user has contracted with the operator to provide. Higher level subscriptions may advantageously gain access to a wider range of contexts.

A UIC 620 receives user input of semantic information. When selected, the UIC 620 may, for example, provide a predetermined list of suggested semantics, and provide a text field for the user to enter manually a desired semantic. Retailers may seek to have their semantics promoted to the top of the list for one or more contexts, which may be provided by contract with the operator of the server 305.

A UIC 625 receives user input of transport mode. Given the context and semantic, different options of transport mode may be available. The user may select all desired modes, or indicate which modes are to be rejected. Modes may include, by way of example and not limitation, tram, bus, trolley, bicycle, foot, escalator, stairs, elevator, ship, tunnel, indoor only, outdoor preferred, weather sensitive, moving walkway, rail, train, bus, taxi, shuttle, plane, wheelchair, motorcart, or the like. In some embodiments, weather dependent criteria may be established to open up or take away transport modes, for example, in response to available weather data (e.g., internet public access information) exceeding certain user predefined thresholds, or criteria (e.g., sleet, hurricane, tornado watch, rain >70% likely, etc. . . . ).

A UIC 630 receives user input of handicap access routes. When selected, the UIC 630 may, for example, filter out routes that are not compliant with accessibility for wheelchairs or other ambulatory assistance needs.

A UIC 635-650 receives user input of itinerary constraint information. When selected, the UIC 640 may, for example, receive a numeric value for minimum or maximum dwell time desired at the active location selected in UIC 610. In some examples, the dwell time may be auto suggested via related semantic information received from the server.

The UIC 645 may, for example, receive a numeric value a latest arrive by time and date. In some examples, the arrive by time may be auto suggested via related semantic information received from the server.

The UIC 650 may, for example, receive a numeric value for a latest depart by time and date. In some examples, the depart by time may be auto suggested via related semantic information received from the server.

An exemplary graphical representation 655 of a waypoint preview displays certain itinerary information, map information and navigational path overlay information within a situs building that contains 3 situses on the itinerary. The preview graphic may include default, user-defined, or calculated itinerary information, such as ETA at waypoint 4, as depicted in this example. An example graphical representation is described in further detail with reference to FIG. 1.

Finally, a UIC 660 receives user input to submit the waypoint criteria to define the itinerary with respect to the situs that matches the semantic and context information. When selected, the UIC 660 may cause a request message to be generated to the server, to request mapping and related semantic information from the server.

In some embodiments, the user interface 600 may include a UIC by which the user can delete a waypoint. In some embodiments, a further UIC may respond to user input to promote or demote a selected waypoint in terms of the order in which the waypoints are sequenced. For example, the UIC may include an arrow up and and arrow down, to cause a selected waypoint to be promoted or demoted, respectively, in the sequence order.

Although various embodiments have been described with reference to the Figures, other embodiments are possible. For example, a mobile software application may receive and display location information on a mobile electronic device that includes a navigation interface for navigating the interior of a building where the schematic and semantic information for the building is obtained from a predetermined entity.

Some implementations may include a mobile software application (mobile app) that interacts with a predetermined entity's web content (e.g., university's website). A map interface of the mobile app interacts with a location tracking system of a mobile electronic device. The map interface may permit a student to find a particular building on campus, for example, the university administration offices. Further, the map interface may provide instructions and suggest routes for the user to get to a desired location on campus. The map interface may receive schematic and semantic information from the universtiy about the buildings. The map interface may further include “zoom” capabilites to display the interior of a building to permit a user to navigate the interior of building. The semantic information may further permit the user to locate a particuler room (e.g., conference room) within a building. The mobile app may permit the user access information about the room (e.g., availability, non-availability, occupant, function, etc.). The mobile app may facilitate the user to schedule the room from within the mobile app, for example.

The mobile app may interface with a website content provider to gather and organize specific information relative to the university and selected by a user of the mobile app. In an exemplary embodiment, information is gathered pertaining to various distinct sources, for example, the university's library, dining facilities, news outlets, and/or any other source that may be available from the university.

The mobile app may advantageously permit a user, for example, a student, to customize the user interface (display) so that information deemed most important by the student is ordered for presentation according to user selectable preferences. The user may also remove a display item that the user chooses not to present, for example, a professor may remove shuttle schedules from the display thereby freeing up an area of the display screen. The professor could then add another display item to the display that may be of higher importance to him/her.

Some aspects of embodiments may be implemented as a computer system. For example, various implementations may include digital and/or analog circuitry, computer hardware, other sensors (e.g., inertial navigation sensors), firmware, software, or combinations thereof. Apparatus elements can be implemented in a computer program product tangibly embodied in an information carrier, e.g., in a machine-readable storage device, for execution by a programmable processor; and methods can be performed by a programmable processor executing a program of instructions to perform functions of various embodiments by operating on input data and generating an output. Some embodiments can be implemented advantageously in one or more computer programs that are executable on a programmable system including at least one programmable processor coupled to receive data and instructions from, and to transmit data and instructions to, a data storage system, at least one input device, and/or at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example and not limitation, both general and special purpose microprocessors, which may include a single processor or one of multiple processors of any kind of computer. Generally, a processor will receive instructions and data from a read-only memory or a random access memory or both. The essential elements of a computer are a processor for executing instructions and one or more memories for storing instructions and data. Storage devices suitable for tangibly embodying computer program instructions and data include all forms of non-volatile memory, including, by way of example, semiconductor memory devices, such as EPROM, EEPROM, and flash memory devices; magnetic disks, such as internal hard disks and removable disks; magneto-optical disks; and, CD-ROM and DVD-ROM disks. The processor and the memory can be supplemented by, or incorporated in, ASICs (application-specific integrated circuits). In some embodiments, the processor and the member can be supplemented by, or incorporated in hardware programmable devices, such as FPGAs, for example.

In some implementations, each system may be programmed with the same or similar information and/or initialized with substantially identical information stored in volatile and/or non-volatile memory. For example, one data interface may be configured to perform auto configuration, auto download, and/or auto update functions when coupled to an appropriate host device, such as a desktop computer or a server.

In some implementations, one or more user-interface features may be custom configured to perform specific functions. An exemplary embodiment may be implemented in a computer system that includes a graphical user interface and/or an Internet browser. To provide for interaction with a user, some implementations may be implemented on a computer having a display device, such as an LCD (liquid crystal display) monitor for displaying information to the user, a keyboard, and a pointing device, such as a mouse or a trackball by which the user can provide input to the computer. For example, wearable devices, such as Google Glasses or other technologies may facilitate input and/or output operations between a user and a system.

In various implementations, the system may communicate using suitable communication methods, equipment, and techniques. For example, the system may communicate with compatible devices (e.g., devices capable of transferring data to and/or from the system) using point-to-point communication in which a message is transported directly from the source to the receiver over a dedicated physical link (e.g., fiber optic link, point-to-point wiring, daisy-chain). The components of the system may exchange information by any form or medium of analog or digital data communication, including packet-based messages on a communication network. Examples of communication networks include, e.g., a LAN (local area network), a WAN (wide area network), MAN (metropolitan area network), wireless and/or optical networks, and the computers and networks forming the Internet. Other implementations may transport messages by broadcasting to all or substantially all devices that are coupled together by a communication network, for example, by using omni-directional radio frequency (RF) signals. Still other implementations may transport messages characterized by high directivity, such as RF signals transmitted using directional (e.g., narrow beam) antennas or infrared signals that may optionally be used with focusing optics. Still other implementations are possible using appropriate interfaces and protocols such as, by way of example and not intended to be limiting, USB 2.0, Firewire, ATA/IDE, RS-232, RS-422, RS-485, 802.11a/b/g/n, Wi-Fi, Ethernet, IrDA, FDDI (fiber distributed data interface), token-ring networks, or multiplexing techniques based on frequency, time, or code division. Some implementations may optionally incorporate features such as error checking and correction (ECC) for data integrity, or security measures, such as encryption (e.g., WEP) and password protection.

One exemplary aspect is a method of operating a handheld device according to a user selected itinerary. The method includes several steps. One step is receiving, in a handheld device, user input semantic information about a desired destination located in a situs building. Another step is to, in response to the received user input, generate a request message for transmission to a remote database, the remote database containing (i) situs location information within a building, and (ii) semantic information linked to the situs location information. The generated request message indicates the semantic information received by user input. Another step is transmitting, via a remote server, the generated request message to the remote database. The method also includes receiving, from the remote database, interior mapping information indicating available paths of travel to a situs within the situs building, wherein the situs was selected from the remote database based on its being linked in the remote database to semantic information matching the semantic information in the request message. Another step is using the received interior mapping information to generate a navigational path to at least one of the situses within the situs building. The method also includes generating mapping information for display on a display device of the handheld device, the generated mapping information including at least a portion of the generated navigational path information located within the situs building.

In some embodiments, the method further may include generating itinerary information for display on a display device. The generated itinerary information may estimate time of arrival at the situs within the situs building, estimated time of travel to the situs within the situs building, and/or estimated latest departure time in order to arrive at the situs within the situs building at a predetermined arrival time. In some examples, the predetermined arrival time may be received by user input to the handheld device. The predetermined arrival time may be received from the remote database where it may be associated with the semantic information contained in the remote database.

By way of illustration and not limitation, the predetermined arrival time may be associated with an event scheduled to occur in the situs at a predetermined start time. For example, the event may be an educational class, the situs a classroom, and the situs location an educational building. The user input semantic information may include a course identifier associated with the educational class. In another example, the event may be a movie, the situs a movie theatre, and the situs building a mall.

In some examples, the method may further include determining current position information of the user. The step of generating a navigational path may further include generating a navigational path from the determined current position to the desired destination within the situs building. The method may further include receiving, from a second remote database, exterior mapping information indicating available paths of travel to the situs building from the determined current position.

In another exemplary aspect, a computer program product (CPP) is tangibly embodied in a storage device. The CPP includes instructions that, when executed, operate a handheld device according to a user selected itinerary. One operation is to receive, in a handheld device, user input semantic information about a desired destination located in a situs building. In response to the received user input, the operations generate a request message for transmission to a remote database, the remote database containing (i) situs location information within a building, and (ii) semantic information linked to the situs location information, wherein the generated request message indicates the semantic information received by user input. The operations also include transmitting, via a remote server, the generated request message to the remote database. Another operation is to receive, from the remote database, interior mapping information indicating available paths of travel to a situs within the situs building. The situs was selected from the remote database based on its being linked in the remote database to semantic information matching the semantic information in the request message. A further operation, using the received interior mapping information, is to generate a navigational path to at least one of the situses within the situs building. Another operation is to generate mapping information for display on a display device of the handheld device. The generated mapping information includes at least a portion of the generated navigational path information located within the situs building.

The CPP may further include operations generating itinerary information for display on a display device. The generated itinerary information may include estimated time of arrival at the situs within the situs building, estimated time of travel to the situs within the situs building, and/or estimated latest departure time in order to arrive at the situs within the situs building at a predetermined arrival time. The predetermined arrival time may be received from the remote database, and be associated with the semantic information contained in the remote database.

A number of implementations have been described. Nevertheless, it will be understood that various modification may be made. For example, advantageous results may be achieved if the steps of the disclosed techniques were performed in a different sequence, or if components of the disclosed systems were combined in a different manner, or if the components were supplemented with other components. Accordingly, other implementations are contemplated to be within the scope of the following claims.

What is claimed is:

1. A method of operating a handheld device according to a user selected itinerary, the method comprising:
receiving, in a handheld device, user input semantic information about a desired destination located in a situs building;
in response to the received user input, generating a request message for transmission to a remote database, the remote database containing (i) situs location information within a building, and (ii) semantic information linked to the situs location information, wherein the generated request message indicates the semantic information received by user input;
transmitting, via a remote server, the generated request message to the remote database;
receiving, from the remote database, interior mapping information indicating 1 5 available paths of travel to a situs within the situs building, wherein the situs was selected from the remote database based on its being linked in the remote database to semantic information matching the semantic information in the request message;
using the received interior mapping information, generating a navigational path to the situs within the situs building; and,
generating mapping information for display on a display device of the handheld device, the generated mapping information including at least a portion of the generated navigational path information located within the situs building.

2. The method of claim 1, further comprising generating itinerary information for display on a display device.

3. The method of claim 2, wherein the generated itinerary information comprises estimated time of arrival at the situs within the situs building.

4. The method of claim 2, wherein the generated itinerary information comprises estimated time of travel to the situs within the situs building.

5. The method of claim 2, wherein the generated itinerary information comprises estimated latest departure time in order to arrive at the situs within the situs building at a predetermined arrival time.

6. The method of claim 5, wherein the predetermined arrival time is received by user input to the handheld device.

7. The method of claim 5, wherein the predetermined arrival time is received from the remote database, the predetermined arrival time being associated with the semantic information contained in the remote database.

8. The method of claim 7, wherein the predetermined arrival time is associated with an event scheduled to occur in the situs at a predetermined start time.

9. The method of claim 8, wherein the event comprises an educational class, the situs comprises a classroom, and the situs location comprises an educational building.

10. The method of claim 9, wherein the user input semantic information comprises a course identifier associated with the educational class.

11. The method of claim 8, wherein the event comprises a movie, the situs comprises a movie theatre, and the situs building comprises a mall.

12. The method of claim 1, further comprising determining current position information of the user.

13. The method of claim 12, wherein the step of generating a navigational path further comprises generating a navigational path from the determined current position to the desired destination within the situs building.

14. The method of claim 12, further comprising receiving, from a second remote database, exterior mapping information indicating available paths of travel to the situs building from the determined current position.

15. A computer program product (CPP) tangibly embodied in a storage device, the CPP including instructions that, when executed, operate a handheld device according to a user selected itinerary, the operations comprising:
receive, in a handheld device, user input semantic information about a desired destination located in a situs building;
in response to the received user input, generate a request message for transmission to a remote database, the remote database containing (i) situs location information within a building, and (ii) semantic information linked to the situs location information, wherein the generated request message indicates the semantic information received by user input;
transmit, via a remote server, the generated request message to the remote database;
receive, from the remote database, interior mapping information indicating available paths of travel to a situs within the situs building, wherein the situs was selected from the remote database based on its being linked in the remote database to semantic information matching the semantic information in the request message;
using the received interior mapping information, generate a navigational path to the situs within the situs building; and,
generate mapping information for display on a display device of the handheld device, the generated mapping information including at least a portion of the generated navigational path information located within the situs building.

16. The CPP of claim 15, further comprising generating itinerary information for display on a display device.

17. The CPP of claim 16, wherein the generated itinerary information comprises estimated time of arrival at the situs within the situs building.

18. The CPP of claim 16, wherein the generated itinerary information comprises estimated time of travel to the situs within the situs building.

19. The CPP of claim 16, wherein the generated itinerary information comprises estimated latest departure time in order to arrive at the situs within the situs building at a predetermined arrival time.

20. The CPP of claim 19, wherein the predetermined arrival time is received from the remote database, the predetermined arrival time being associated with the semantic information contained in the remote database.
